(19) United States
(12) Patent Application Publication
(10) Pub. No.: US 2009/0094537 A1
(43) Pub. Date: Apr. 9, 2009

(54) METHOD FOR ALLOWING USERS OF A DOCUMENT TO PASS MESSAGES TO EACH OTHER IN A CONTEXT-SPECIFIC MANNER

(76) Inventor: Travis Alber, Peoria, IL (US)

Correspondence Address: TRAVIS ALBER, 2831 W. PINE HILL LANE, PEORIA, IL, 61614, US

(21) Appl. No.: 12/245,724

(22) Filed: Oct. 4, 2008

Related U.S. Application Data
(60) Provisional application No. 61/130,334, filed on Oct. 5, 2007.

(51) Int. Cl. G06F 3/048

(52) U.S. Cl. 715/758

(57) ABSTRACT

This invention relates to digital reading applications—specifically the ability to discuss documents contextually, in real time or asynchronously, in a virtual space within a document. The preferred embodiment of this method allows for discussions to take place inline, in parallel, or in any fashion wherein user conversations can be tied to the user's location within a document. This method has two possible core modules: a program that allows a free-flowing real-time conversation between people filtered according to relationship between the portion of the document they are looking at and the portion others are looking at (one embodiment of this could be an instant messaging program), and a context-based comment and response system linked to selections or parts or elements of the document (and taking place in real-time or archived formats), with the ability to make those comments visible relative to a user's motion through the document.

### CROSS REFERENCE TO RELATED APPLICATIONS

This application claims the benefit of provisional patent application No. 61/130,334, filed Oct. 5, 2007 by the present inventor.

### FEDERALLY SPONSORED RESEARCH

Not Applicable

### SEQUENCE LISTING OR PROGRAM

Not Applicable

### INTRODUCTION

This invention relates to digital reading applications—specifically the ability to discuss documents contextually, in real time or asynchronously, in a virtual space within a document. The method allows for discussions to take place inline, in parallel, or in any fashion wherein user conversations can be tied to the user's location or selection within a document. In its preferred embodiment, this method has two possible core modules: a program that allows a free-flowing real-time conversation between people filtered according the portion of the document they are looking at (one embodiment of this could be an instant messaging program), and a selection- or context-based comment-and-response system (with real-time or archived formats), with the ability to make those comments visible as a person moves through the document.

### BACKGROUND OF THE INVENTION

This invention relates to software that allows multiple users to view and interact with a document. The World Wide Web is a good example of an area that will benefit from this invention.

1. Prior Art

Currently people viewing a document on a computer cannot easily select pieces of a document in real time and comment to others within a designated proximity or with a shared selection inside that document. Moreover, topic-based comments and responses posted between people are rarely tied directly to the content (such as selection- or position-based topics) or integrated with real-time conversations. Instead, people often make comments in forums outside the document. These outside conversations force people to use a multitude of technologies. Electronic bulletin boards are standard for annotations, comments and asynchronous communication, Instant messaging services, with text, audio and/or video, are used for real time conversations, and word-processing and note-taking programs are used to annotate documents. The lack of integration between conversation and content isolates users, limits context-specific conversations, complicates the possibilities of shared annotations, scatters individual notes across technologies, and generally limits a person's and a community's understanding of a document's content.

For example, U.S. Pat. No. 7,139,977 is a document reader, but is limited by lack of community and annotation capability. This solution does not allow a user to connect with other users in a virtual space inside the document. It also has a limited perception of a document—often assuming it to be text-only. Instant messaging programs, as defined by U.S. Pat. No. 6,212,548, create a multi-user chat room where people can discuss things in real time. However, they lack the capability to filter relevant, real-time comments according to context—ie., position, selection, proximity—within a document. The idea of reading online has been around for some time, but the idea of document space hasn't really been explored. The shared annotations, mentioned in U.S. Pat. No. 5,146,552, could be considered precursors to the document space comment-and-response module, but they lack the flexibility of real-time shared notes.

2. Objects and Advantages

No digital reading device formerly developed allows users to communicate contextually, with free-form conversation and archived context-based discussions within a document.

This method has a number of advantages over prior art. It allows people to conceive of a document as a physical space in which users exist, so that user actions and events can be seen as originating from a relative position in the document, in much the same way that modern GPS systems work in the physical world. For example, a user's friends might be interested to know that he is reading the first paragraph in a certain news article, especially if they have the opportunity to discuss it with him. A user in a reading group might also be interested to know how far ahead or behind he is in the text as compared to the rest of the group. Another advantage is that it enables software to filter metadata, messages, annotations and events through a user's preferences in regards to the range of document content they are most interested in. Ultimately this method will allow people to connect and read the text more closely, and will encourage real-time context-based discussions.

### SUMMARY

The invention is a method of enabling context-specific communication for multiple users of a document. A document, for the purposes of this method, can be considered text, imagery, animation, binary file, or any combination of these things, which form a collection that users need to discuss contextually. The components of the method include a document and/or a document reader, a contextual real-time event-filtering system, and may include a context-based comment and response system. The distinctiveness of this method is that it allows the tight integration of these elements, regardless of implementation, by tracking a user's position within a document space, which together creates an experience closely tied to the document content.

### DRAWINGS

FIG. 1 shows a flow diagram representing the process by which a user selects and joins a document space.

FIG. 2 shows a block diagram representing the combined functionality of chat, document viewing, and annotation.

FIG. 3 shows a block diagram representing the document space itself and the relationship of users within it.

FIG. 4 shows a block diagram representing a method of transforming user uploads into document spaces.

### DETAILED DESCRIPTION—PREFERRED EMBODIMENT

This reading system is unique for a number of reasons. It is a document system which presents documents in a paginated manner similar to many handheld reading devices, but unlike others, it is web-based and does not require any application download, desktop software, or special hardware (other than a laptop or other mobile device with an Internet connection and a web browser). It is the first such document system to integrate messaging and a context-based comment-and-response system with paginated (as opposed to scrolled) document viewing. Finally, it is the first such system to offer an embodiment that adopts the newly created standard for electronic publications, the IDPF's OPS 2.0 (Open Packaging Structure), and as such will enable a networked community of readers to upload and share documents without fear of competing standards.

In the preferred embodiment, the document viewer presents and enables navigation of content. One embodiment of the document viewer could include a dynamically served work of literature (a document pulled from a server), with an interactive list of chapter titles to choose from, a forward and back button for “page” navigation and the ability to reflow the text (change the size and therefore the placement of content with in a document).

The real-time, free-flowing conversation module (sometimes called a messaging client) is a real-time discussion that happens within a virtual space defined by limits within the content. The conversations between users in the virtual space are filtered according to the users' distance between each other, as measured between their positions in the document space and their own preferences as to how far messages are to be relayed within that space. One embodiment of the real-time conversation module could be a group discussing content via an instant messaging window, where the group is limited by a chapter, number of paragraphs, a single selection of content, or any kind of document-related position. As users move within the document, they appear or disappear from other users' instant messaging environments, so that all real-time communication is dependent on the user's location within a document. These conversations can be conducted via text, audio, video, or any communication tool that can be integrated with a document.

The context-based comment-and-response module allows a user to attach a comment to a specific part of the document. That comment can be shared publicly or be limited to a particular group of users. It is also possible that the comment could be private and only viewable by its creator. If public, another user may discover the comment while progressing through the document, and may post a response. The user may also make a new comment at that location. One example of context-based conversation might include a limited community of people who, in reading an e-book together, comment on the author's intent within a particular passage. These context-based exchanges may also be user-selection-based, as they relate directly to a portion of a document. They can be real-time, asynchronous, or archived.

### DESCRIPTION OF FIGURES

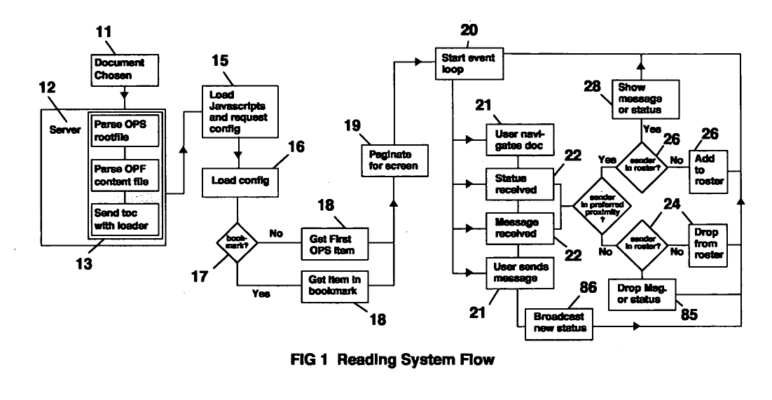

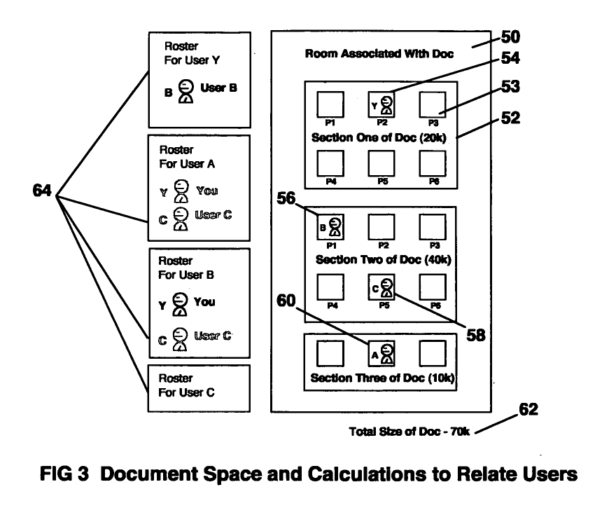

In FIG. 1, one embodiment, the user chooses a document in the Reading System to begin the process of viewing it and interacting with other users (11). The Server (12) locates the resource for the document and begins the process of parsing the document package structure, according to the OEBPS 2.0 specification (13). It finds the rootfile, locates the content file named there, parses the content file to determine package structure, and returns information about that structure along with a loader script for the Javascript application framework (15). The Javascript application requests a configuration (16), again from the web server (12), and awaits document metadata, user session information, and bookmark data, if any (17). If a bookmark is found, the system will request the referenced item (a document or document section) from the OPS table of contents (18). If not, it will request the first item in the OPS contents, per the OPS 2.0 spec. When the item has loaded, the reading system will paginate it according to screen dimensions and device type (19). At this point, the system enters the main loop, polling for various events and responding accordingly (20). Any user navigation or message sending (21) will trigger a broadcast of the user's new position in the document and other status information (86). Likewise, if a status or message is received, first a check will be made as to the proximity of the sender to the current user (see FIG. 3 description for an explanation of this concept). Since the document space is a multi-user space, all users will receive such events and messages, and all clients will perform the same check. The proximity roster, or the temporary group formed by applying the user's proximity preferences after each event or message is received, is in constant flux. If the sender is within the preferred proximity of the current user and NOT in the user's proximity roster, the sender is added to the roster (26). If the sender is already in the roster, and the message comes from outside the preferred proximity of the current user, the sender is dropped from the roster (24). Finally, if the sender is neither in the roster nor sending from within the preferred proximity, the message is ignored (85). A sender's presence in a proximity roster guarantees a message will be displayed, or an event will be registered (28). From there, the system forwards back to the main event loop.

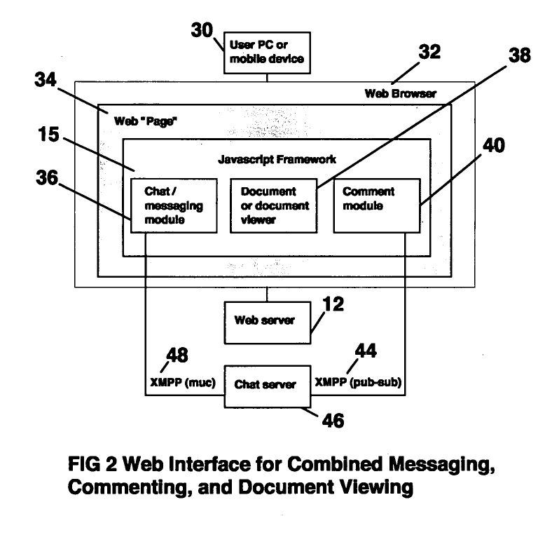

In FIG. 2, in the preferred embodiment, the user's PC or mobile device (30) interfaces with the Web Server (12) and the Chat Server (46) through a combination of environments. The web application itself runs in a modern web browser (32), although software that allows a similar interface to a networked computer environment would suffice. The web “page” itself (34) is an execution environment for a Javascript Framework (15). The main script creates interface elements for the real-time free-flowing conversation module, sometimes called chat (36), context-based comment-and-response module (40), and document viewing panels (38). User interactions are made and displayed in these areas. The chat area features a log of messages sent from within the virtual document space. The reader displays content from the document one “page” at a time, meaning enough to fit in the available area allotted by the script. The comment-and-response panel responds to user selections within the document, offering the chance to comment on specific passages, and to either keep those passages private, or make them available to everyone who views the document. Finally, it should be noted that while the document reader uses a common pagination technique and client-side memory to store and display its segments, and makes requests to the web server (12), the comment and chat panes both require constant contact with the chat server (46). This is because both use a binding form of the standard http protocol used for standard web pages called http-bind. The protocol which utilizes this is called XMPP, an XML-based protocol which equates streams of data with XML documents. The difference between the way that the two modules connect and the way the comment panel connect is the difference between the protocol extensions used by each. The chat module uses the MUC extension (48), and the comment module uses the Pub-Sub extension (44). In FIG. 3 the document is re-conceived as a multi-user space akin to a “chat room” (50). This is what we refer to when we use the term “document space.” Within this space, the document itself is divided into manageable chunks of data, which we can call sections (52). These divisions may either be transparent or obvious to users, but the system must be able to relate two unique users in different parts of the document. In this example, there is a user in Section One, in a 20 k slice of data, and a user in Section Two, in a 40 k slice of data; these users should feel as though they are in the same unified chunk of data—the document itself. To do this, the system uses a formula to calculate the percentage of absolute document progress for each user. The main variables needed for this are: the overall document size, including all related or linked assets (such as multimedia, images, tables, appendices, audio supplements—note: remote resources or fallback elements (placeholder elements substituted when an element isn't available) shall be considered to be the size of the element for which they substitute); the size of each non-fallback portion of the divided document; and the location of each user expressed in terms of fractional progress through both document and section. In terms of this figure, User C's position (58) is expressed as ⅓ of the way through the document and ⅚ of the way through Section Two, approximately 76%. User A (60) is ⅔ of the way through Section Three, or 2/3 of the document plus ⅔ of the last section, or about 95% through the document.

In order to form proximity rosters (64), regardless of whether they are displayed to users or not, a calculation must be applied to determine which users appear in a particular user's proximity.

One metaphor to explain proximity is signal strength. A single user can be seen as a broadcasting entity. The proximity of any user to a given broadcasting entity increases the specificity of messaging about the document, and is therefore desirable for fostering more granular discussions. Users do not always want the widest possible broadcast scope. Users are often interested in hearing the messages of those closest to the portion of the document that they are currently examining. At times, they might like to shorten that range, to focus on a cluster of paragraphs. At other times, they might want to extend the range to include others—when, for example, the document space is sparsely populated. Proximity can be tuned to only include very close positions, or expanded to include all positions in a document.

In the preferred embodiment of the virtual document space, a user has the ability to set proximity as a preference setting. When a message or presence comes in from another user, it includes positional information. This is weighed against user preferences. The calculation, an additive percentage problem, follows.

Calculation of Positions (refer to FIG. 3 and FIG. 3 description):

B is ⅙*100=16.67% of the way through Section Two. This is the whole of Section One, 20 k, plus 16.67% of 40 k (the size of Section Two), for a total of 20 k+6.67 k=26.67/70 k, or 38% of the way through the whole document.

A is ⅔ through Section Three, or 0.33*10 k+40 k+20 k =63.3 k. Divide this by 70 k total document size and multiply by 100=95.2%

For C the calculation is (((⅚*40 k )+20 k) 544 / 70 k )*100=76% progress.

For Y, lets first abstract the formula to:

$$( \frac{\begin{matrix}( \frac{Current Page in Section}{Total Pages in Section} * Section File Size ) + \\ \sum Preceding Section File Sizes\end{matrix}}{\sum All Sections File Sizes} ) * 100$$

Solving this, we get.

2/6*100=33.33% of the way through Section One. Based on filesize, this is 6.67 k of a 70 k document, or 9.5% of the way through the whole document.

### Therefore:

Proximity Setting of User A:
95.2% is A's Position (absolute location, percentage through the document)
45% is A's Proximity Preference (range of conversation A will allow)
Proximity Setting encompasses all the users with a location in the range of 50%-100% through the document (roster then includes A and C)

Proximity Setting of User B.
38% is B's Position (absolute location, percentage through the document)
40% is B's Proximity Preference (range of conversation B will allow
Proximity setting encompasses all the users with a location in the range of 0%-78% through the document (roster includes Y, B and C)

Proximity Setting of User C:
76% is C's Position (absolute location, percentage through the document)
10% is C's Proximity Preference (range of conversation C will allow)
Proximity setting encompasses all the users with a location in the range of 66%-86% through the document (roster includes only C)

Proximity Setting of User Y:
9.5% is Y's Position (absolute location, percentage through the document)
30% is Y's Proximity Preference (range of conversation Y will allow)
Proximity setting encompasses all the users with a location in the range of 0%-39% through the document (roster includes Y and B)

Users are added or dropped from the rosters as needed to maintain proper proximity scope. Any time a user navigates to another location in a document, her new position is broadcast to all applications which have registered to receive it, and the client software of each room member updates that member's roster accordingly. Thus, messages are only sent to and received from members listed in one's proximity roster (64).

The system should respect these preferences in a bilateral fashion, which means that one person's proximity preferences may affect the outcome of another person's filter (64). In such cases, the users who wish to limit their proximity only become available to the users who fall within that range. In this embodiment, this is called Consideration of Reciprocity.

In numeral 64, some users in rosters are grayed out. This represents the Consideration of Reciprocity. For example, user A is 95.2% through the document, and would like to converse with any users located within a 45% range of her location. This means she'll speak to and hear from anyone whose location is between 55% and 100% of the document. User C is located 76% of they way through the document, so A should be able to speak to C. However, although C is within A's range, he doesn't reciprocate. He only wants to converse with people who are located within a distance of 10% of his location—that is, users located between 66% and 86% of the document—so C doesn't reciprocate. In (64), A knows C is within her audible range, and appears in her roster, but she also knows, thanks to a certain designation (here, grey color), that C isn't listening; A can't be heard.

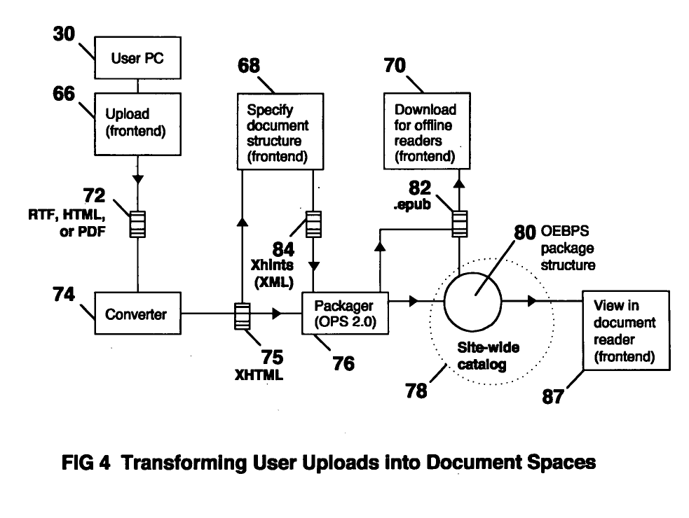

FIG. 4 outlines a method for users to transform their own documents into document-spaces in the preferred embodiment. The open-source standard Open Package Structure (OPS), officially recommended by the International Digital Publishing Forum (IDPF), is the choice of format in the preferred embodiment, as it is based on open standards and has been adopted by many industry leaders. The conversion process begins with a document uploaded from the user's PC or mobile device (30), through a web page, or networked, interface (66). The system determines the document type from a few options: PDF, RTF and HTML (72). Once the type has been verified as acceptable, the system converts it into a standardized form of XHTML markup (75). The converter (74) performs various transformations, such as removing any potentially unsafe scripting or remote links, standardizing the header and any important metadata it may contain. At this point, the user has been directed to a second web page (68), which displays the standardized version of the uploaded document and invites the user to designate section breaks and other modifications of the document. The result of the user interaction at this step is an Xhints file (84) a proprietary XML intermediary format that will be used by the packaging element (76) to break the document into sections. The packaging component (76) uses the unique identifiers cited in the Xhints file (84) to break the converted XHTML document (75) into separate XHTML container files, based on section type. It also creates the necessary root and index files (also based on the section designations), required by the OPS specification. After packaging, the document is made immediately available in the site-wide document catalog (78), unless the user has designated it as a private document, in which case, it will be actively available only to that user, and not searchable by any other user. It is made available both as an .epub file, which is the downloadable version and may be used in any desktop reading software which supports the OPS epub standard, and as a shareable document-space in this system's online reader.

### REFERENCE NUMERALS

11—User specified document in catalog (by unique ID)
12—Web server running PHP framework
13—OPS parsing process
15—Javascript framework running in client side execution environment (FIG. 2, 32)
16—Check for config and/or request one
17—Check for bookmark (intra-document location pointer) in config
18—Retrieve first doc in OPF spine or item specified by bookmark
19—Paginate for screen/device
20—Main event loop
21—Navigation by user or message sent events
22—Status or message received events
24—Handler for not in-proximity, but in roster
26—Handler for in-proximity, but not in roster
28—Show message or status from event, update interface
30—User PC or mobile device
32—Web browser (execution environment on client side)
34—Virtual space known as the “web page”—not to be confused with the document at hand
36—Chat interface for multi-user document space, displays proximity and positional information about users
38—Document viewer/reader, contains main navigational elements for document traversal
40—Comment interface, responds to document selection actions by user, interfaces with web server (FIG. 1, 12)
44—Chat streams using publish-subscribe model of XMPP protocol
46—Chat server (instant messaging) using XMPP protocol
48—Chat streams using Multi-user chat extensions to XMPP protocol
50—Multi-user chat room associated with a specific document
52—Section, defined as a single item (file) in an OPS package (document), with file size noted for calculations
53—Page, defined as enough of the document to fit on screen space used by Document Viewer (FIG. 2, 38)
54—User Y position, defined as the position of the first character (or containing markup node) of the element at the top of User Y's page, between the first and last characters of the section (see formulas for extrapolated calculations)
56—User B position
58—User C position in Section Two of document
60—User A position in Section Three
62—Total size of the collection of top-level files which can be navigated by a user, noted for calculation purposes
64—User rosters, with black and gray avatars to show availability/unavailability based on reciprocal proximities.
66—Upload screen for single document
68—Document structure tool (allows user to designate split-points and split-levels, as well as designate various types of document elements or structural divisions)
70—Download screen with link to OPS epub package file (.zip formatted OPS collection) generated by Server, as well as link to navigate the package in the Document Viewer interface
72—RTF, PDF, or HTML document uploaded to server in temporary location
74—Document converter
75—Converted user upload, XHTML compliant, standardized for Reading System use
76—Packager, used to create OPS package files and directories from converted docs (75)
78—Site wide catalog of OPS documents
80—OEBPS package structure, generated by Packager (76)
82—Zipped version of OPS structure (80) (.epub file according to the OPS spec)
84—Xhints file, XML formatted hints file generated by Document Structure Tool (68). Enhances ability of Packager (76) to correctly split converted uploads (75)
85—Drop user message if not in proximity
86—Broadcast new status
87—View file in document reader

I claim:

1. A method of enabling context-specific exchanges between multiple users of a document, comprising:
(a) providing a single document, defined as text, video, audio, binary file, or any combination thereof, for review by multiple users on separate computers, mobile devices or networked systems
(b) providing software which uses the document as a virtual space which is defined by its beginning, end, elements and sub-elements, in which user actions, relative proximities, and positions are tracked and transmitted so that
(1) filtering of conversation and the comments of other users according to a person's location in the document can be made, and
(2) filtering of conversation and the comments of other users according to a person's range or proximity preference can be made, and
(3) grouping by the exclusion or inclusion of other users based on certain other preferences can be made
whereby a user can view and converse, with proximity filter settings, as well as comment and/or respond to comments, inside a document's virtual space.

2. The method of enabling context-specific exchanges between multiple users of a document of claim 1, further including a context-based comment and response system for users, linked to the document structure, that is real-time or asynchronous, and may be moderated by filtration and grouping,

3. The method of enabling context-specific exchanges between multiple users of a document of claim 1, wherein said method is providing a relationship between an application in which a document is viewed by multiple users and an extension or interface of that application, or a separate application or applications, wherein data about users' positions in the document or actions upon the document is stored, displayed, aggregated, broadcast, published or otherwise transmitted to other users.
